(19) United States
(12) Patent Application Publication
(10) Pub. No.: US 2008/0143257 A1
(43) Pub. Date: Jun. 19, 2008

(54) Plasma display panel

(76) Inventors: Young-Gil Yoo, Suwon-si (KR); Sang-Hyun Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/000,628

(22) Filed: Dec. 14, 2007

(30) Foreign Application Priority Data
Dec. 15, 2006 (KR) 10-2006-0128926
Jun. 25, 2007 (KR) 10-2007-0062485

(51) Int. Cl. H01J 17/49

(52) U.S. Cl. 313/586

(57) ABSTRACT

A plasma display panel (PDP) includes front and rear substrates spaced apart and facing each other, barrier ribs between the front and rear substrates to define a plurality of discharge cells, a plurality of electrodes between the front and rear substrates to generate a discharge, a light transmitting layer including a blue pigment, and at least one blue phosphor layer in the discharge cells, the phosphor layer including a phosphor material represented by Ba_{1-x-y}Sr_{y}MgₚAl_{q}Oᵣ:Euₓ, where 0.001≦x≦0.1, 0.021≦y≦0.3, p=1, q=10 or 14, and r=17 or 23.

### BACKGROUND OF THE INVENTION

1. Field of the Invention

Embodiments of the present invention relate to a plasma display panel. More particularly, embodiments of the present invention relate to a plasma display panel having enhanced brightness and color purity.

2. Description of the Related Art

Plasma display panels (PDPs) may refer to flat panel displays that display images via gas discharge, and may exhibit excellent display characteristics, e.g., brightness, contrast, afterimage and viewing angle, on thin/large screens. More specifically, vacuum ultraviolet (VUV) light may be generated by discharge of gases between panels of the PDP to excite a phosphor material, so that lowering of the energy level of the excited phosphor material may trigger emission of visible light to display images.

A conventional PDP may include, e.g., a blue phosphor to emit visible blue light. However, brightness of the blue phosphor may be reciprocally related to color purity thereof. Thus, improvement of brightness of the blue phosphor in the conventional PDP may result in a relative decrease of the blue color purity.

### SUMMARY OF THE INVENTION

Embodiments of the present invention are therefore directed to a plasma display panel (PDP), which substantially overcomes one or more of the disadvantages of the related art.

It is therefore a feature of an embodiment of the present invention to provide a PDP with a structure exhibiting improved brightness and color purity of blue light.

At least one of the above and other features and advantages of the present invention may be realized by providing a PDP, including front and rear substrates spaced apart and facing each other, barrier ribs between the front and rear substrates to define a plurality of discharge cells, a plurality of electrodes between the front and rear substrates to generate a discharge, a light transmitting layer including a blue pigment, and at least one blue phosphor layer in the discharge cells, the phosphor layer including a phosphor material represented by Ba_{1-x-y}Sr_{y}MgₚAl_{q}Oᵣ:Euₓ, where 0.001≦x≦0.1, 0.021≦y≦0.3, p=1, q=10 or 14, and r=17 or 23. The phosphor material of the phosphor layer may be Ba_{0.65}Sr_{0.25}MgAl₁₀O₁₇:Eu_{0.1}, Ba_{0.69}Sr_{0.21}MgAl1₀O₁₇:Eu_{0.1}, or Ba_{0.6}Sr_{0.3}MgAl₁₀O₁₇:Eu_{0.1}. The blue pigment may include one or more of copper oxide (CuO), cobalt oxide (CoO), nickel oxide (NiO), chromium oxide (Cr₂O₃), praseodymium oxide (Pr₂O₃), and/or iron oxide (Fe₂O₃).

The front substrate may be the light transmitting layer. The rear substrate may be the light transmitting layer. The front and rear substrates may be light transmitting layers. The PDP may further include a dielectric layer between the front and rear substrates. The dielectric layer may be the light transmitting layer. The dielectric layer may be a front dielectric layer on the front substrate. The dielectric layer may be a rear dielectric layer on the rear substrate. A thickness of the light transmitting layer may be about 29 μm to about 32 μm. An upper surface of the barrier ribs may be colored by a color complementary to a color of the blue pigment of the light transmitting layer.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates an exploded perspective view of a plasma display panel (PDP) according to an embodiment of the present invention; and

FIG. 2 illustrates a graph of transmittance variation with respect to thickness of a light transmitting layer of a PDP according to an embodiment of the present invention.

### DETAILED DESCRIPTION OF THE INVENTION

Korean Patent Application Nos. 10-2006-0128926 and No. 10-2007-0062485, filed on Dec. 15, 2006, and on Jun. 25, 2007, respectively, in the Korean Intellectual Property Office, and entitled: “Plasma Display Panel,” are incorporated by reference herein in their entirety.

Embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

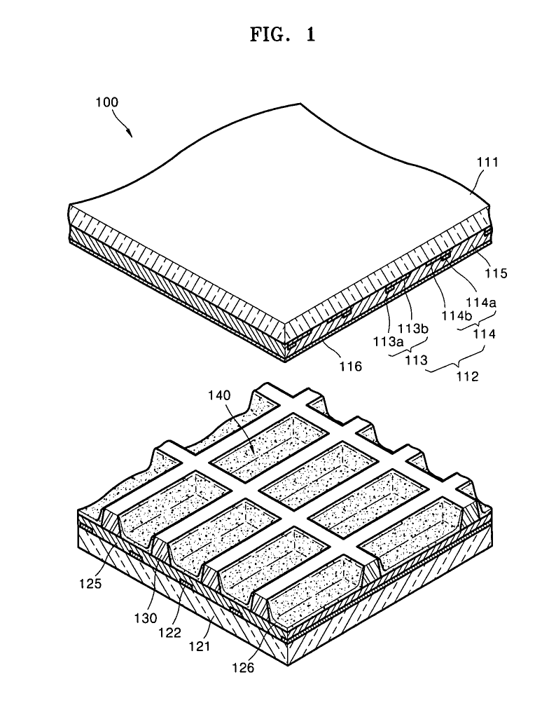

An exemplary embodiment of a plasma display panel (PDP) according to the present invention will be described with reference to FIGS. 1-4. Referring to FIG. 1, a PDP 100 may include a front substrate 111, a rear substrate 121, pairs of sustain electrodes 112, a front dielectric layer 115, a protective layer 116, address electrodes 122, a rear dielectric layer 125, barrier ribs 130, phosphor layers 126, and a discharge gas, e.g., xenon (Xe), neon (Ne), and so forth.

The front and rear substrates 111 and 121 of the PDP 100 may be spaced apart, and may face each other. The front substrate 111 and/or the rear substrate 121 may be formed of a material having high light transmittance, e.g., a material including glass. For example, the front substrate 111 may be transparent, so visible light generated by discharge may be transmitted through the front substrate 111. In another example, the front substrate 111 may be opaque and the rear substrate 121 may be transparent, so visible light generated by discharge may be transmitted through the rear substrate 121. In yet another example, both the front and rear substrates 111 and 121 may be transparent. The front substrate 111 may be colored in order to improve contrast in a bright environment by reducing reflective brightness. Further, a filter may be formed on or inside the front substrate 111 and/or the rear substrate 121 for correcting colors and/or for shielding electromagnetic waves.

The pairs of sustain electrodes 112 of the PDP 100 may include X electrodes 113 and Y electrodes 114. For example, one pair of sustain electrodes 112 may include a X electrode 113 and a Y electrode 114. The pairs of sustain electrodes 112 may be symmetrically disposed on the front substrate 111, such that discharge gaps may be formed therebetween to correspond to discharge cells 140. The X electrodes 113 and Y electrodes 114 may include bus electrodes 113a and 114a, respectively, formed of metal, and may include transparent electrodes 113b and 114b, respectively, formed of a transparent material, e.g., indium tin oxide (ITO). The bus electrodes 113a and 114a may extend along one direction on the front substrate 111 to face the rear substrate 121, and may have excellent electrical conductivity. The transparent electrodes 113b and 114b may be disposed on the bus electrodes 113a and 114a, respectively, to face the rear substrate 121. For example, the PDP 100 may be a three-electrode surface discharge type PDP. However, other PDP types, e.g., a PDP having a facing discharge structure with separated pairs of sustain electrodes, a PDP having a facing discharge structure with facing sustain electrodes, a PDP having a facing discharge structure with sustain electrodes surrounded by dielectric material, and so forth, are within the scope of the present invention.

The front dielectric layer 115 of the PDP 100 may be formed on the front substrate 111 to face the rear substrate 121 by, e.g., a screen coating method, a thick coating method, or a like method, to coat the sustain electrodes 112. The front dielectric layer 115 may be formed of a dielectric material, e.g., one or more of lead oxide (PbO), boron oxide (B₂0₃), and/or silicon oxide (Si0₂). The front dielectric layer 115 may prevent or substantially minimize damage to the sustain electrodes 112 due to direct collision with charged particles and/or electrons, and/or may induce accumulation of electric charges on walls of the sustain electrodes 112.

The protective layer 116 of the PDP 100 may be formed on the front dielectric layer 115 to face the rear substrate 121, i.e., the front dielectric layer 115 may be between the front substrate 111 and the protective layer 116. The protective layer 116 may be formed of, e.g., magnesium oxide (MgO), by, e.g., sputtering and electron-beam deposition after the front dielectric layer 115 is formed, thereby exhibiting high visible light transmittance. The protective layer 116 may prevent or substantially minimize damage to the front dielectric layer 115 due to collisions thereof with charged particles and/or electrons during the discharge, and may reduce a discharge voltage by generating a large number of secondary electrons during the discharge.

The address electrodes 122 of the PDP 100 may extend on the rear substrate 121 to face the front substrate 111. The address electrodes 122 may extend along a direction perpendicular to a direction of the sustain electrodes 112, and may be positioned to correspond to an array of discharge cells 140 along a direction perpendicular to a direction of the sustain electrodes 112. An intersection point between a pair of sustain electrodes 112 and an address electrode 122 may correspond to a unit discharge cell 140. The address electrodes 122 may generate address discharge, i.e., between the Y electrodes 114 and the address electrodes 122, to reduce a voltage initiating the sustain discharge, thereby facilitating sustain discharge between the X and Y electrodes 113 and 114. When the address discharge is terminated, wall charges may be accumulated on the X and Y electrodes 113 and 114, thereby facilitating the sustain discharge between the X and Y electrodes 113 and 114.

The rear dielectric layer 125 of the PDP 100 may be formed on the rear substrate 121 to face the front substrate 11, and may coat the address electrodes 122. The rear dielectric layer 125 may be formed of a dielectric material, e.g., one or more of PbO, B₂0₃, and/or Si0₂, thereby preventing or substantially minimizing damage to the address electrodes 122 from collisions with charged particles and/or electrons during the discharge.

The barrier ribs 130 of the PDP 100 may be disposed between the front substrate 111 and the rear substrate 121 to define a plurality of the discharge cells 140. That is, the barrier ribs 130 may have any suitable structure, e.g., a closed type waffle, and may be positioned to partition a space between the front and rear substrates 111 and 121 to form the discharge cells 140. The discharge cells 140 may be filled with gas, followed by sealing of the front and rear substrates 111 and 121 by a sealing member, e.g., a frit glass formed on edges of the front and rear substrates 111 and 121. For example, the front and rear substrates 111 and 121 may be sealed by performing a heat treatment process at about 400° C. The front and rear substrates 111 and 121 may be sealed after depositing the phosphor layers 126 therebetween.

The phosphor layers 126 of the PDP 100 may include red, green, and/or blue phosphor layers emitting visible red, green, and/or blue light, respectively, upon excitation by ultraviolet light. The phosphor layers 126 may be formed on bottom surfaces of the discharge cells 140 and on sidewalls of the barrier ribs 130, e.g., a phosphor material may be applied to a bottom surface of the discharge cells 140 and heat treated at about 500° C. The red phosphor layers may include, e.g., Y(V,P)O₄:Eu, the green phosphor layers may include, e.g., Zn₂Si0₄:Mn, and the blue phosphor layers may include a phosphor material having a general formula of Ba_{1-x-y}Sr_{y}MgₚAl_{q}Or:Euₓ, wherein x and y may indicate relative molar fractions of europium (Eu) and strontium (Sr), respectively.

More specifically, x may equal from about 0.001 to about 0.1, and y may equal from about 0.021 to about 0.3. When x is lower than about 0.001, the brightness of the blue phosphor may decrease, thereby reducing overall efficiency of the PDP. When x is higher than about 0.1, the blue phosphor may be degraded during formation of the PDP 100. When y is lower than about 0.21, barium (Ba) may not be properly substituted with Sr, thereby reducing brightness. When y is higher than about 0.3, blue color purity may be too low, thereby rendering the blue phosphor layers impractical for blue color display despite high brightness of the phosphor layers. The values of p, q, and r may not be limited. For example, p may equal 1, q may equal 0, and r may equal 17. In another example, p may equal 1, q may equal 14, and r may equal 23.

Without intending to be bound by theory, it is believed that when using a phosphor material having the general formula of Ba_{1-x-y}Sr_{y}MgₚAl_{q}Or:Euₓ to emit blue light, a partial Ba—O site in the phosphor material may be substituted with Sr, thereby facilitating energy transmission and increasing energy efficiency. Further, degradation due to the Ba—O site may be prevented or substantially minimized. More specifically, a conventional PDP may include a conventional BAM, i.e., Ba₁₋ₓMgAl₁₀O₁₇:Euₓ where 0.03≦x≦0.25, as a blue phosphor material. Accordingly, Eu²⁺, i.e., a sub-lubricant, in the conventional BAM may be oxidized during heat treatment, e.g., sealing of the front and rear substrates 111 and 121, thereby causing the conventional BAM degradation. Further, the blue phosphor in the conventional PDP may be degraded by ultraviolet light generated during the discharge, e.g., light wavelength of about 147 nm and about 172 nm, thereby reducing the intensity of the emitted light. Accordingly, using a phosphor material having the general formula of Ba_{1-x-y}Sr_{y}MgₚAl_{q}Oᵣ:Euₓ, i.e., use of Sr substitution, according to embodiments of the present invention may prevent or substantially minimize degradation of the blue phosphor material, thereby increasing brightness thereof.

Since blue color purity may decrease as brightness thereof increases, color purity in the PDP 100 may be adjusted with respect to the increased brightness by using a blue-colored light transmitting layer. Visible light emitted from the discharge cells 140 to form images may be transmitted through the blue-colored light transmitting layer, so that color purity of the formed images may be improved. For example, the light transmitting layer may be one or more of the front substrate 111, the front dielectric layer 115, the rear substrate 121 and/or the rear dielectric layer 125. The light transmitting layer may have a predetermined thickness in order to improve color purity of light transmitted therethrough. For example, the light transmitting layer may have a thickness of about 29 μm to about 32 μm. A light transmitting layer having a thickness below about 28 μm or above about 33 μm may exhibit a reduced transmittance, e.g., in the red, green, and blue wavelengths, as compared to, e.g., a light transmitting layer having a thickness of about 29 μm to about 32 μm.

For example, if the front dielectric layer 115 is the light transmitting layer of the PDP 100, the front dielectric layer 115 may include a blue pigment, e.g., one or more of copper oxide (CuO), cobalt oxide (CoO), nickel oxide (NiO), chromium oxide (Cr₂0₃), praseodymium oxide (Pr₂0₃), and/or iron oxide (Fe₂0₃). In particular, the blue pigment may be added to the dielectric material, and the dielectric material with the blue pigment may be cut into particles having a diameter of about 1 μm to about 5 μm. The particles may be mixed with any suitable binder and solvent to form a paste. The paste may be coated on the front substrate 111, followed by sintering at a temperature of about 550° C. to about 600° C. for about 10 minutes to about 30 minutes to finalize the front dielectric layer.

In this respect, it is noted that forming a light transmitting layer including a blue pigment, i.e., direct layer coloring during formation thereof, may simplify manufacturing of the PDP in terms of manufacturing steps and overall time, as compared to a PDP including, e.g., a color filter to control color purity. In addition, the weight ratio of the blue pigment may be varied to control color purity, i.e., the y color coordinate. Further, a layer (not shown) colored by a pigment having a complementary color with respect to the color of the light transmitting layer may be included on the upper surface of the barrier ribs 130 to improve color purity of the PDP 100. Alternatively, the barrier ribs 130 may be colored directly, e.g., include a pigment, with a complementary color with respect to the color of the light transmitting layer.

Operation of the PDP 100 may be as follows. An address voltage may be applied between the address electrodes 122 and the Y electrodes 114 to generate an address discharge, thereby selecting discharge cells 140 to be operated, i.e., discharge cells 140 in which a sustain discharge will occur. Next, a sustain voltage may be applied between the X electrodes 113 and Y electrodes 114 in the selected discharge cells 140, so positive ions accumulated on the Y electrodes 114 and electrons accumulated on the X electrodes 113 may collide with each other to facilitate the sustain discharge. Voltage pulses applied to the X electrodes 113 and Y electrodes 114 may be alternated to maintain the discharge. The sustain discharge may excite the discharge gas in the discharge cells 140, so reducing the sustain discharge may reduce an energy level of the excited discharge gas to emit vacuum ultraviolet (VUV) light, i.e., light having a wavelength in a range of about 147 nm to about 200 nm. The VUV light may excite the phosphor layers 126, so the phosphor layers 126 may emit visible light to display images.

### EXAMPLES

### Examples 1-5

Five PDPs according to an embodiment of the preset invention were prepared. In particular, a phosphor material having the formula Ba_{1-x-y}Sr_{y}MgAl₁₀O₁₇:Euₓ (x=0.1) was used to form a phosphor layer emitting blue light. The molar ratio of Sr was varied, and color purity, relative brightness, and efficiency of each PDP were measured. Color purity and relative brightness were measured using a CA-100⁺ brightness meter. In this respect, color purity refers to a y-coordinate of the blue color on the Commision Internationale de L'Ec I airage (CIE) scale. The efficiency was calculated as a ratio between relative brightness and color purity. Examples 1-5 were compared to a PDP of Comparative Example 1 including a conventional BAM phosphor, i.e., a BAM including no Sr, as a blue phosphor. The results are reported in Table 1.

TABLE 1

| | Sr molar ratio | Relative brightness | | Efficiency |
|---|---|---|---|---|
| | (y) | (cd/m²) | CIEy | (L/CIEy) |
| Comparative | 0 | 100 | 0.060 | 1667 |
| Example 1 | | | | |
| Example 1 | 0.15 | 109 | 0.065 | 1677 |
| Example 2 | 0.21 | 113 | 0.068 | 1662 |
| Example 3 | 0.25 | 120 | 0.073 | 1690 |
| Example 4 | 0.3 | 124 | 0.074 | 1676 |
| Example 5 | 0.35 | 125 | 0.076 | 1645 |

As shown in Table 1, a PDP according to embodiments of the present invention, i.e., Examples 1-5, exhibited an increased brightness. In particular, when y was in a range of about 0.2 to about 0.3, the PDP exhibited an increase of about 15% to about 25% in brightness as compared to the PDP of Comparative Example 1.

### Example 6

A PDP was prepared in a substantially same method used in Examples 1-5, with the exception of using a blue pigment, i.e., one or more of CuO, CoO, NiO, Cr₂0₃, Pr₂0₃, and/or Fe₂0₃, in the front dielectric layer of the PDP. Ba_{0.65}Sr_{0.25}MgAl₁₀O₁₇:Eu_{0.1} was used as a blue phosphor. The color purity of the PDP was measured to be (0.144, 0.073). In other words, use of the blue pigment adjusted the color purity from about (0.144, 0.068) to about (0.148, 0.068). That is, the PDP of Example 6 exhibited an improvement of 0.005 in the y-coordinate. Accordingly, use of a light transmitting layer including a blue pigment may improve color purity of the emitted light.

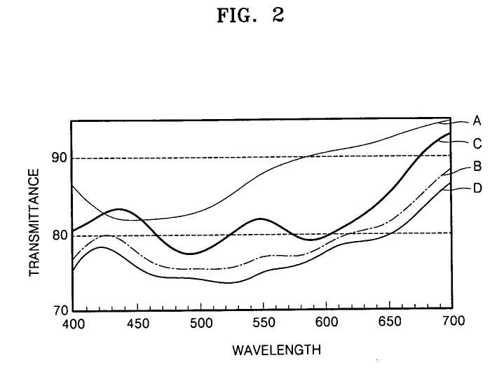

With respect to FIG. 2, three PDPs were prepared in a substantially same method used in Example 6, with the exception of forming a light transmitting layer of different thicknesses according to Table 2 below.

TABLE 2

| | Transmittance Layer |
|---|---|
| Curves | Thickness (μm) |
| A | 0 |
| B | <28 |
| C | 30 |
| D | <33 |

Curve A exhibited high transmittance in red, green, and blue wavelengths, and in non-visible light wavelengths. In addition, transmittance was high at about 590 nm due to Ne emission. Curves B and D exhibited a relatively low transmittance in the red, green, and blue wavelength ranges, as compared to curve C. Curve C exhibited an increased light transmittance at the blue wavelength range of about 450 nm, the green wavelength range of about 550 nm, and the red wavelength range of about 630 nm. It is further noted that transmittance of about 590 nm due to Ne emission, i.e., emission resulting due to discharged gas, was decreased, thereby improving an overall color purity of the PDP.

A PDP according to embodiments of the present invention may be advantageous in providing both improved brightness and color purity of blue light emitted from blue phosphor layers. In particular, use of a blue phosphor material of the general formula Ba_{1-x-y}SryMgAl₁₀O₁₇:Euₓ may increase brightness by an average of about 20%, as compared to a PDP including BAM with no Sr. Further, the y color coordinate of the emitted blue light may be adjusted by adding a blue pigment to any light transmitting layer and/or element the emitted blue light may pass through, e.g., the front dielectric layer and/or the front substrate, thereby enhancing color purity with respect to the improved brightness. Therefore, the PDP according to embodiments of the present invention may have improved brightness and color purity.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
front and rear substrates spaced apart and facing each other;
barrier ribs between the front and rear substrates to define a plurality of discharge cells;
a plurality of electrodes between the front and rear substrates to generate a discharge;
a light transmitting layer including a blue pigment; and
at least one blue phosphor layer in the discharge cells, the phosphor layer including a phosphor material represented by Ba_{1-x-y}Sr_{y}MgₚAl_{q}Or:Euₓ, where 0.001≦x≦0.1, 0.021≦y≦0.3, p=1, q=10 or 14, and r=17 or 23.

2. The PDP as claimed in claim 1, wherein the phosphor material of the phosphor layer is Ba_{0.65}Sr_{0.25}MgAl₁₀O₁₇:Eu_{0.1}, Ba_{0.69}Sr_{0.21}MgAl1₀O₁₇:Eu_{0.1}, or Ba_{0.6}Sr_{0.3}MgAl₁₀O₁₇:Eu_{0.1}.

3. The PDP as claimed in claim 1, wherein the blue pigment includes one or more of copper oxide (CuO), cobalt oxide (CoO), nickel oxide (NiO), chromium oxide (Cr₂O₃), praseodymium oxide (Pr₂O₃), and/or iron oxide (Fe₂O₃).

4. The PDP as claimed in claim 1, wherein the front substrate is the light transmitting layer.

5. The PDP as claimed in claim 1, wherein the rear substrate is the light transmitting layer.

6. The PDP as claimed in claim 1, wherein the front and rear substrates are light transmitting layers.

7. The PDP as claimed in claim 1, further comprising a dielectric layer between the front and rear substrates.

8. The PDP as claimed in claim 7, wherein the dielectric layer is the light transmitting layer.

9. The PDP as claimed in claim 8, wherein the dielectric layer is a front dielectric layer on the front substrate.

10. The PDP as claimed in claim 8, wherein the dielectric layer is a rear dielectric layer on the rear substrate.

11. The PDP as claimed in claim 1, wherein a thickness of the light transmitting layer is about 29 μm to about 32 μm.

12. The PDP as claimed in claim 1, wherein an upper surface of the barrier ribs is colored by a color complementary to a color of the blue pigment of the light transmitting layer.
